(19) United States
(12) Patent Application Publication
(10) Pub. No.: US 2015/0153691 A1
(43) Pub. Date: Jun. 4, 2015

(54) IMAGE HEATING APPARATUS AND IMAGE FORMING APPARATUS INCLUDING THE IMAGE HEATING APPARATUS

(71) Applicant: CANON KABUSHIKI KAISHA, Tokyo (JP)

(72) Inventor: Kazuaki Ono, Kashiwa-shi (JP)

(21) Appl. No.: 14/556,441

(22) Filed: Dec. 1, 2014

(30) Foreign Application Priority Data
Dec. 2, 2013 (JP) 2013-249058

(51) Int. Cl. G03G 15/20

(52) U.S. Cl. CPC G03G 15/2053

(57) ABSTRACT

An image heating apparatus includes: an endless belt configured to heat a toner image on a recording material at a nip; an electroconductive portion provided along a circumferential direction of the endless belt at a longitudinal end portion of the endless belt; a first contact portion and a second contact portion which contact the electroconductive portion at different positions with respect to the circumferential direction; an electric voltage supplying portion configured to supply an electric voltage to the electroconductive portion through the first contact portion; and a detecting portion configured to detect, whether or not electrical conduction is established, through the second contact portion.

### FIELD OF THE INVENTION AND RELATED ART

The present invention relates to an image heating apparatus and an image forming apparatus including the image heating apparatus.

As a conventional fixing device to be mounted in an image forming apparatus, such as a printer or a copying machine, of an electrophotographic type, a fixing device (image heating apparatus) using a fixing film (endless belt) has been proposed (Japanese Laid-Open Patent Application (JP-A) 2000-338807.

In the case where such a fixing film is used in a period exceeding a period of guarantee, there is a liability that the fixing film is rarely broken. Specifically, in some cases, the fixing film is cracked at a longitudinal end portion thereof. In such cases, it is required that the crack is detected early and then a user is urged to exchange the fixing film.

### SUMMARY OF THE INVENTION

According to an aspect of the present invention, there is provided an image heating apparatus comprising: an endless belt configured to heat a toner image on a recording material at a nip; an electroconductive portion provided along a circumferential direction of the endless belt at a longitudinal end portion of the endless belt; a first contact portion and a second contact portion which contact the electroconductive portion at different positions with respect to the circumferential direction; an electric voltage supplying portion configured to supply an electric voltage to the electroconductive portion through the first contact portion; and a detecting portion configured to detect, whether or not electrical conduction is established, through the second contact portion.

According to another aspect of the present invention, there is provided an image forming apparatus comprising: an image forming portion configured to form a toner image on a recording material; an endless belt configured to heat, at a nip, the toner image formed on the recording material by the image forming portion; an electroconductive portion provided along a circumferential direction of the endless belt at a longitudinal end portion of the endless belt; a first contact portion and a second contact portion which contact the electroconductive portion at different positions with respect to the circumferential direction; an electric voltage supplying portion configured to supply an electric voltage to the electroconductive portion through the first contact portion; a detecting portion configured to detect, whether or not electrical conduction is established, through the second contact portion; and a sending portion configured to send a signal for notifying an error when the detecting portion does not detect that the electrical conduction is not established although the electric voltage supplying portion provides electric voltage supply.

According to a further aspect of the present invention, there is provided an image heating apparatus comprising: an endless belt configured to heat a toner image on a recording material at a nip; a roller configured to form a nip in cooperation with the endless belt and configured to drive the endless belt, a first electroconductive portion provided along a circumferential direction of the endless belt at a longitudinal end portion of the endless belt; a first contact portion contacting the first electroconductive portion; a second portion, provided on a core metal of the roller, contacting the first electroconductive portion; a second contact contacting the core metal of the roller; an electric voltage supplying portion configured to supply an electric voltage to the second electroconductive portion through the second contact portion; and a detecting portion configured to detect, whether or not electrical conduction is established, through the first contact portion.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of a fixing device according to First Embodiment.

FIG. 2 is a schematic illustration of the fixing device in First Embodiment.

FIG. 3 is a schematic sectional view of a heater in the fixing device in First Embodiment.

FIG. 4 is a flowchart regarding current detection of a fixing film bias in First Embodiment.

FIG. 5 is a schematic sectional view showing a state of fixing film breakage due to film shift in a direction toward an electroconductive portion in First Embodiment.

FIG. 6 is a schematic sectional view showing the state of fixing film breakage due to film shift in an opposite direction to the direction toward the electroconductive portion in First Embodiment.

FIGS. 7, 8 and 9 are schematic illustrations of fixing devices according to Second Embodiment, Third Embodiment and Fourth Embodiment, respectively.

FIG. 10 is a schematic illustration of a fixing belt in Fifth Embodiment.

FIG. 11 is a schematic illustration of another fixing belt in Fifth Embodiment.

In FIG. 12, (a) and (b) are schematic illustrations of a fixing device in Sixth Embodiment.

FIG. 13 is a schematic illustration of an image forming portion of an image forming apparatus in which the fixing device is mounted.

FIG. 14 is a schematic sectional view of the fixing film.

FIG. 15 is a schematic illustration of the fixing film at a longitudinal end portion.

### DESCRIPTION OF THE EMBODIMENTS

Embodiments of the present invention will be described specifically with reference to the drawings.

### First Embodiment

### (Image Forming Apparatus)

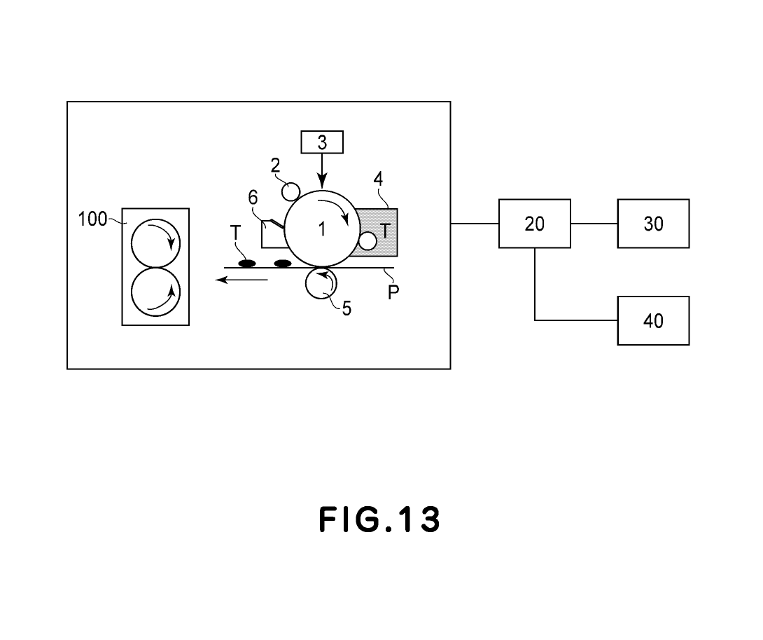

FIG. 13 is a schematic illustration showing a principal structural portion of an image forming apparatus using an electrophotographic process. A photosensitive drum 1 as an image bearing member is electrically charged uniformly by a charging roller as a charging device and thereafter is exposed to laser light by an exposure device 3 depending on information on an image to be formed, so that an electrostatic latent image is formed. The electrostatic latent image is developed with a toner T (having a negative polarity as a normal charge polarity thereof) which is a developer contained in a developing device 4, so that a toner T image is formed on the photosensitive drum 1. The toner T image on the photosensitive drum 1 is transferred onto a recording material P by a transfer roller 5.

The toner T on the recording material P is fixed on the recording material P by being heated and pressed by a fixing device 100 as an image heating apparatus, and then is discharged from the image forming apparatus, thus forming an image on the recording material P. A transfer residual toner on the photosensitive drum 1 is removed by a cleaning device 6, so that image formation is to be effected again.

To the image forming apparatus, a personal computer 40 is connected directly or via a network. For example, in the case where the image forming apparatus is used as a printer, an image forming signal from the personal computer 40 is received by the image forming apparatus, so that the image formation is started to print the image. In the case where the image forming apparatus is used as a copying machine, the image forming signal of an original image read by an unshown scanner is received by the image forming apparatus, so that the image formation is started to copy the image.

Further, in the case where the image forming apparatus is used as a facsimile machine, the image forming signal sent from an unshown telephone line is received by the image forming apparatus, so that the image formation is started to print the image. A controller (CPU) 20 of the image forming apparatus is connected to an image forming portion (for performing the charging, the exposure, the development, the transfer, the fixing and the cleaning). The controller (CPU) 20 as a sending portion controls the image forming apparatus, and in the case where abnormality (error) or warning of the image forming apparatus is detected, sends a signal to that effect. Specifically, the controller 20 sends the signal to a display portion 30 of the image forming apparatus to cause the display portion 30 to display a message of the abnormality or warning. For example, in the case where the toner is used up, a message to the effect that the toner should be supplied or a toner cartridge should be exchanged is displayed at the display portion 30. In the case where an image forming member is broken or reaches an end of its lifetime, a massage to the effect that the member which is broken or which reaches the end of its lifetime should be exchanged or a massage that a user contacts a service person of a manufacturer is displayed at the display portion 30. As a result, the user is urged to take measures against the abnormality or warning.

Further, the controller 20 urges the user to take the measures by displaying a massage to that effect in the case where the abnormality of the fixing device described below is detected.

### (Fixing Device)

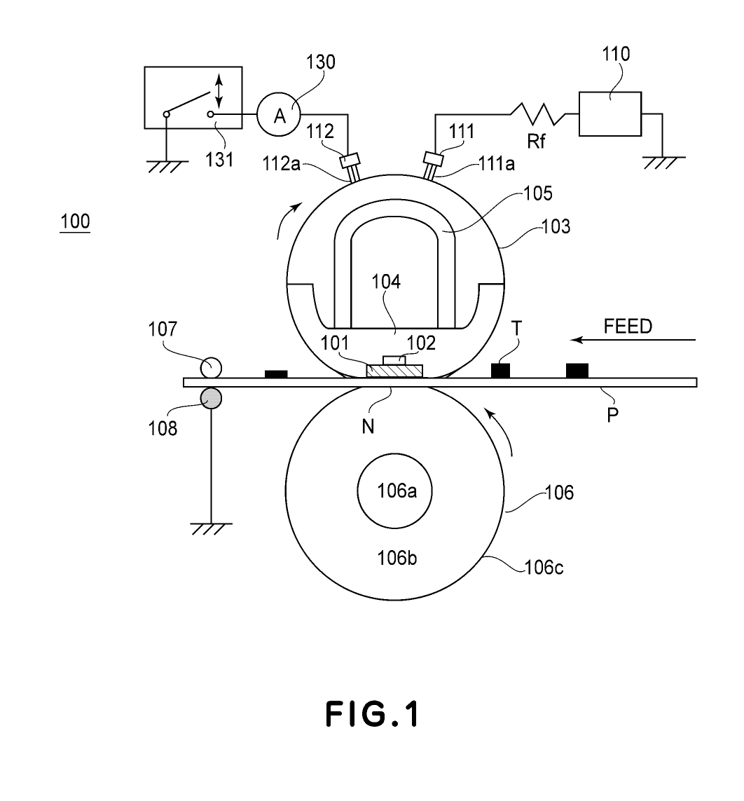

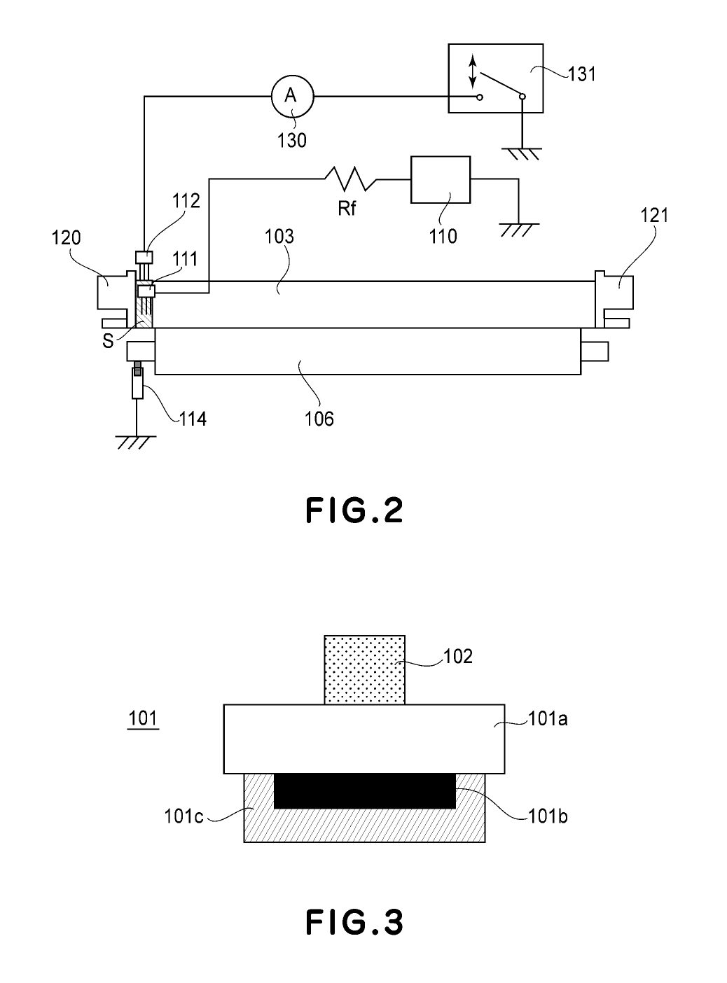

FIGS. 1 and 2 are schematic sectional view and a schematic illustration, respectively, of a fixing device 100 (FIG. 13) of a film heating type in this embodiment. The fixing device 100 in FIG. 1 includes a heater 101, a fixing film 103 as a first rotatable member (endless belt) movable in contact with the heater 101, and a pressing roller 106 forming a nip N with the heater 101 via the fixing film 103.

The fixing film 103 is press-contacted to the pressing roller 106 (rotatable driving member) by the heater 101, so that the nip N is formed. Further, the pressing roller 106 is rotationally driven by a motor as a rotating mechanism, so that the fixing film 103 is rotated by the drive of the pressing roller 106 while sliding on the heater 101.

By causing the toner image on the recording material P to enter the nip N, heat of the heater 101 is imparted to the recording material P and the toner image via the fixing film 103, so that the toner image on the recording material P is melted and pressed and thus is fixed on the recording material P.

This fixing device of the film heating type is short in time required from start of energization to the heater until a temperature of the fixing device reaches a fixable temperature, and therefore has such an advantage that electric power consumption during stand-by in which the image forming apparatus awaits a print instruction is small.

### 1) Fixing Film

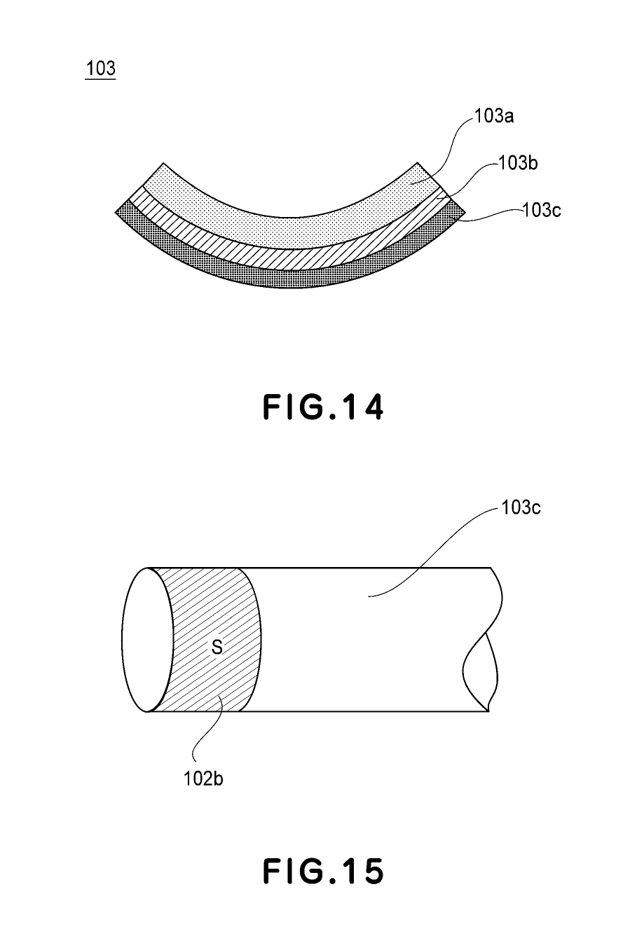

FIG. 14 is a schematic sectional view showing a layer structure of the fixing film 103. An innermost layer of the fixing film 103 is a base layer 103a of a material, excellent in heat-resistant property and anti-wearing property, such as polyimide. An outermost layer is a top layer 103c of a material, excellent in parting property and heat-resistant property, such as PFA or PTFE, and is an insulating layer of about 1×10¹⁰ to 1×10¹⁵ (Ωcm) in volume resistivity. An intermediate layer 103b is a printer layer (adhesive layer) for adhesively bonding the base layer 103a and the top layer 103c, and is an electroconductive layer in which electroconductive particles of carbon black or the like are dispersed in a primer to provide electroconductivity.

Specifically, the fixing film 103 includes a cylindrical member as the base layer 103a, formed of a heat-resistant polyimide material, which is 24 mm in inner diameter, 235 mm in length and 60 μm in thickness, and includes a 4 μm-thick electroconductive primer layer coated, as the intermediate layer 103b, on the base layer 103a. The fixing film 103 further includes, as the top layer 103c, a 15 μm-thick heat-resistant parting layer of PFA, PTFE or the like, which is coated on the intermediate layer 103b, and is externally fitted on a supporting member 104 and is rotatably disposed.

FIG. 15 is a schematic illustration of the fixing film 103 at a longitudinal end portion of the fixing film 103. A hatched portion in FIG. 15 is an electroconductive portion S where the top layer 103c does not exist and where a part of the electroconductive intermediate layer 103b is exposed substantially over a full circumference thereof. This electroconductive portion S is a region where a bias is to be applied to the fixing film 103. Specifically, the electroconductive portion S is about 7 mm in width.

### 2) Heater

FIG. 3 is a schematic sectional view of the heater 101. The heat 101 is constituted by a heater substrate 101a, a heat-generating element 101b and a protective layer 101c. The heater substrate of ceramic or the like is, e.g., in the case of the image forming apparatus in which A4-sized paper is passed through the fixing device in a short edge feeding manner, 250 mm in length, 8 mm in width and 1 mm in thickness. The heat-generating elements 101b generating heat by energization is formed by applying a material, e.g., by screen printing in a length of 220 mm, a width of 5 mm and a thickness of 20 μm, and then by baking the material. On the heat-generating element 101b, a glass layer as the protective layer 101c is formed by applying a material by screen printing and then by baking the material to have a thickness of about 50 μm.

A thermistor as a temperature detecting means for detecting a temperature of the heater 101 is provided in press-contact with the heater substrate 101a. The controller 20 (FIG. 13) adjusts an electric voltage supplied to the heat-generating element 101b so that the temperature of the heater 101 is a desired fixing temperature (e.g., 200° C.), on the basis of the thermistor 102.

The heater 101 is supported and fixed on the supporting member 104 shown in FIG. 1, and on the supporting member 104, a U-shaped pressing stay 105 is provided. The heater 101 is pressed toward the pressing 106 by an unshown pressing mechanism at longitudinal end portions of the pressing stay 105, so that the nip N is formed.

### 3) Pressing Roller

The pressing roller 106 is, e.g., constituted by coating, as an elastic layer 106b, a 3 mm-thick electroconductive silicone rubber-made heat-resistant elastic layer on a core metal 106a (FIG. 1) which is 15 mm in diameter and which is formed of aluminum, and then by coating, as a surface layer 106c, a 50 μm-thick PFA tube which is a heat-resistant parting layer on the elastic layer 106b.

The length of the elastic layer 106b of the pressing roller 106 is 225 mm so as to shorter than the length of the fixing film 103 and be longer than the length of the heat-generating element 101b of the heater 101. The elastic layer 106b of the pressing roller 106 has electroconductivity of about 1×10⁶ Ωcm in volume resistivity in order to stabilize a surface potential of the pressing roller 106 to lower a degree of fixing offset. Further, the more metal (second electroconductive portion) 106a of the pressing roller 106 is connected to the ground via a terminal member 114 in which a carbon chip is disposed on a leaf spring. A width of the nip N with respect to a rotational direction is about 6 mm.

### 4) Sheet Discharging Roller Pair

In a downstream side of the nip N with respect to a sheet feeding direction, a sheet discharging roller pair 107 and 108 is provided. The upper sheet discharging roller 107 is constituted by an insulating material, and the lower sheet discharging roller 108 is constituted by an electroconductive material, and is connected to the ground.

### (Fixing Film Bias)

As shown in FIGS. 1 and 2, from a bias voltage source 110 as an electric voltage supplying portion, a bias having the same polarity as the charge polarity of the toner T is applied, via an electroconductive brush 111 as an electrical contact portion, to the electroconductive portion S which is the electroconductive intermediate layer 103b exposed at the end portion of the fixing film 103. The electroconductive brush 111 is disposed at a first position 111a with respect to a circumferential direction of the fixing film 103, and is constituted so as to contact the electroconductive portion S.

In this embodiment, the normal charge polarity of the toner T is, e.g., negative, and a voltage of −500 (V) is applied from the bias voltage source 110. Thus, the voltage of −500 (V) having the same polarity as the charge polarity of the toner T is applied to the fixing film 103, so that the surface potential of the fixing film 103 is about −500 (V).

On the other hand, the electroconductive elastic layer 106b of the pressing roller 106 is connected to the ground via the core metal 106a, but the surface layer 106c is formed with the PFA tube, and therefore the surface potential of the pressing roller 106 is about −100 (V) to about −200 (V). Due to a surface potential difference between the fixing film 103 and the pressing roller 106, the negatively charged toner T is prevented from depositing on the fixing film 103, so that the degree of fixing offset is decreased.

Further, by this bias (voltage) application, a minute current flows in a path in the order of the bias voltage source 110, the intermediate layer 103b, the top layer 103c, the recording material P, the lower sheet discharging roller 108, and the ground. As a result, at the nip N, an electric field directed in a direction in which a force for pressing the toner T toward the recording material P acts on the toner T is formed, s that a degree of improper fixing is lowered.

In FIGS. 1 and 2, between the bias voltage source 110 and the electroconductive brush 111, a resistor Rf=50 (MΩ) for satisfying product specification is provided. For this reason, a current flowing from the bias voltage source 110 to the lower sheet discharging roller 108 is very small, and thus the surface potential of the fixing film 103 little lowers, so that the surface potential of the fixing film 103 is about −500 (V).

### (Current Detection of Fixing Film Bias)

In this embodiment, a mechanism for detecting the current passing through the electroconductive portion S of the fixing film 103 using the above-described bias, for preventing the offset, applied to the fixing film 103 is provided. That is, in the case where an absolute value of the detected current is smaller than a predetermined value (specifically, in the case where the electrical conduction is not established), it is discriminated that breakage of the fixing film 103 or failure of the bias voltage source 110 or the like occurred.

That is, in this embodiment, as shown in FIGS. 1 and 2, the electroconductive brush 112 as the electrical contact portion is contacted to the electroconductive portion S at the end portion of the fixing film 103, and the current is detected when the electric voltage is supplied to the bias voltage source 110. The electroconductive brush 112 is constituted so that the electroconductive brush 112 is disposed at a second position 112a with respect to the circumferential direction of the fixing film 103 and is contacted to the electroconductive portion S.

In this embodiment, specifically, the current passing through a circuit, as a detection circuit, in the order of the bias voltage source 110, the electroconductive brush 111, the intermediate layer 103b, the electroconductive brush 112, an ammeter 130, a switching means (switch portion) 131 and the ground is detected by the ammeter 130. Further, in the case where the absolute value of the detected current is smaller than the predetermined value (i.e., in the case where the electrical conduction is not established), it is discriminated that the breakage of the fixing film 103 or the failure of the bias voltage source 110 or the like occurred.

In this embodiment, as shown in FIGS. 1 and 2, an electric voltage supplying circuit (path toward the electroconductive brush 112) of the fixing film bias via the electroconductive brush 112 and another current circuit (path in a side where the current flows apart from the electroconductive brush 112) are disposed.

### (Flowchart of Current Detection of Fixing Film Bias)

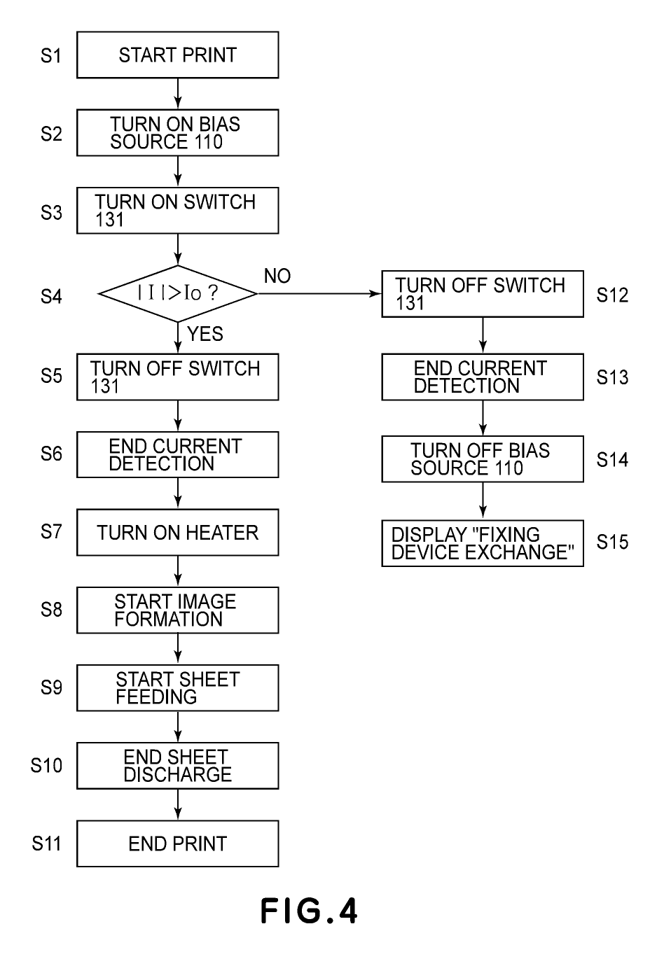

FIG. 4 is a flowchart of an operation regarding current detection of the fixing film bias in this embodiment. Specifically, the controller (functioning as a part of a detecting portion) 20 controls various devices, so that a step of detecting the current of the fixing film bias is carried out.

IN S1, a print signal from, e.g., the personal computer 40 is detected by the controller 20 of the image forming apparatus, so that printing is started. The personal computer 40 may be connected with the controller 20 of the image forming apparatus via the network or may also be connected with the controller 20 of the image forming apparatus via a USB port or the like without via the network.

Then, in S2, the bias voltage source 110 for the fixing film 103 is turned on (closed), so that the voltage of about −500 (V) is applied to the fixing film 103. Then, in S3, the switching means (switch portion) 131 for electrically turning on and off the detection circuit, so that the current is passed through the ammeter 130. Depending on a value of the current passing through the ammeter 130, a value of the bias applied from the bias voltage source 110 and the like value, a value of the current passing through the ammeter 130 may also be adjusted by inserting an unshown resistor into a path in the order of the electroconductive 112, the switching means 131 and the ground.

In S3, an AV |V| of a current value I detected by the ammeter 130 and a predetermined current value Io are compared with each other. In the case of |I|>Io, the controller 20 discriminates that there are no breakage of the fixing film 103 and no failure of the bias voltage source 110 (i.e., that states of these members are normal) (Yes of S4 in FIG. 4). Then, in S5, the switching means 131 is turned off (opened), so that the current passing through the ammeter 130 is interrupted. This current detection is carried out over at least a period in which the fixing film 103 rotates one full turn.

When the current passes through the ammeter 130, the surface potential of the fixing film 130 is lowered, so that an effect of decreasing degrees of the fixing offset and fixing trailing is lowered. Therefore, it is preferable that the switching means 131 is turned off (opened) during a fixing step (during the image heating process) in which the recording material P passes through the nip N.

Then, in S6, the current detection is ended. Thereafter, in S7, the electric voltage is supplied to the heater 101 of the fixing device, so that the temperature of the heater 101 is increased up to the fixing temperature, and at the same time, pre-fixing rotation in which the fixing film 103 is rotated by rotation of the pressing roller 106 is started. Then, in S8, image formation is started at the image forming portion.

Then, in S9, the recording material P is fed while being timed to the image on the photosensitive drum, so that the toner image is formed on the recording material P and is fixed on the recording material P, and then the recording material P is fed by the sheet discharging roller pair 107 and 108. Thereafter, in S10, it is checked that the recording material P is discharged to an outside of the image forming apparatus. Then, in 511, the printing operation is ended. At this time, the energization to the heater 101 is turned off, and the rotation of the pressing roller 106 is stopped, and the bias application from the bias voltage source 110 is turned off, so that the image formation is ended.

Next, a flow of the case of |I|≦Io in S4 will be described. In S4, in the case of |I|≦Io, the controller discriminates that the breakage of the fixing film 103 or the failure of the bias voltage source 110 occurs (i.e., that the state of the associated member is abnormal) (N of S4 in FIG. 4). Thereafter, in S12, the switching means 131 is turned off (opened), so that the current passing through the ammeter 130 is interrupted. Then, in NS13, the current detection is ended. Further, in S14, the bias application from the bias voltage source 110 is turned off.

Then, in S15, the controller 20 as the sending portion sends a signal for notifying an error and displays a message of “fixing device exchange” at the displaying portion 30 of the image forming apparatus main assembly. Further, in the case where the image forming apparatus is used as a printer connected with the personal computer 40 via a network cable, the controller 20 sends the signal for notifying the personal computer 40 of the error. Then, the controller 20 displays a message of “fixing device exchange” at a monitor connected with the personal computer. The current detection of the fixing film bias in this embodiment is made as described above with reference to FIG. 4.

In FIG. 4, the energization to the heater 101 is made after the current value of the fixing film bias is measured. This is because when the measurement of the current value of the fixing film bias is made after the energization to the heater 101, the current value of the fixing film bias somewhat fluctuates, in a period of a frequency of the AC bias supplied to the heater 101, depending on the AC bias. Therefore, in order to detect the current value of the fixing film bias with high accuracy, the energization to the heater 101 is carried out after the measurement of the current value of the fixing film bias.

However, depending on the fixing device, in the case where importance is placed on shortening of a time from receipt of the print signal by the image forming apparatus to start the image formation, the rotation of the pressing roller 106 is started simultaneously with the turning-on of the fixing film bias application in S2 of FIG. 4. Then, the energization to the heater 101 is started. Such a constitution may also be employed. In this case, current detection accuracy somewhat lowers, but it is possible to detect the current value.

In this embodiment, in the case where the voltage of −500 (V) is outputted from the bias voltage source 110, the current value I, in a normal state, detected in S4 in FIG. 4 is about −6 μA to about −10 μA (i.e., |I| of current I is 6-10 μA). The absolute value |I| of the current value is detected at a somewhat low level due to a contamination or the like of the electroconductive brushes 111 and 112 in continuous use. Therefore, e.g., Io=3 (μA) is set, so that it is possible to accurately detect the breakage of the fixing film 103 and the failure of the bias voltage source 110.

### (Breakage of Fixing Film)

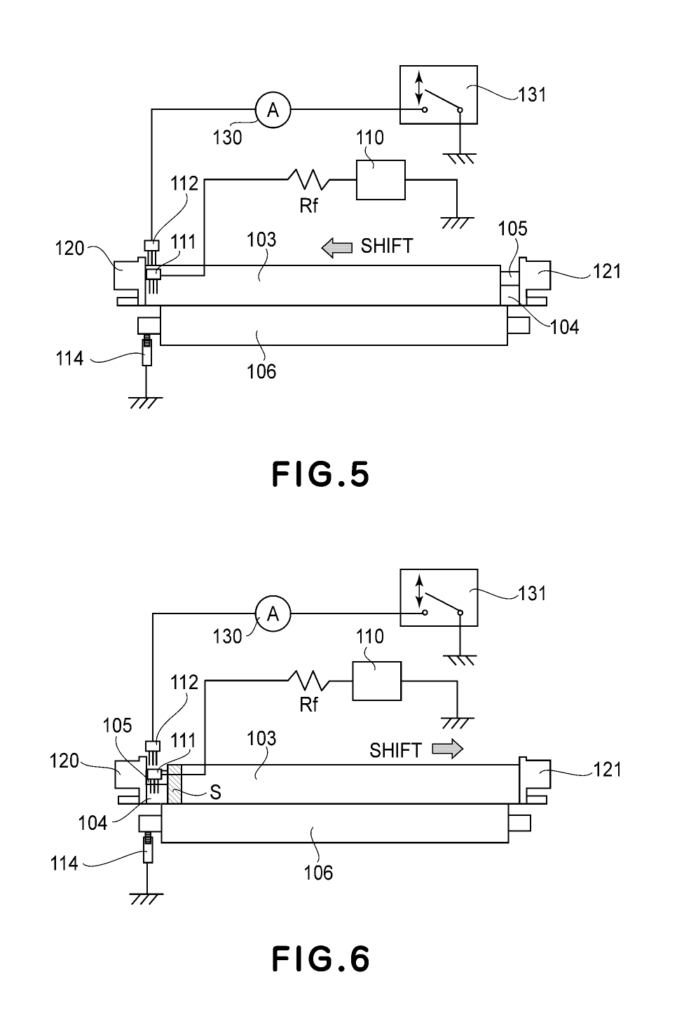

Next, a state in which the breakage of the fixing film is detected will be described. FIG. 5 shows the case (breakage) where a force for shifting the fixing film 103 toward the electroconductive portion S of the fixing film 103 and then the fixing film 103 is shortened by abrasion by rubbing of the fixing film 103 with a flange 120 in the electroconductive portion S side. As shown in FIG. 5, the fixing film 103 is abraded in the electroconductive portion S side to eliminate the exposed portion (electroconductive portion S) of the intermediate layer 103b thereof, so that the electroconductive brushes 111 and 112 contacts the insulating or high-resistant top layer 103c of the fixing film 103. As a result, the bias application connection to the fixing film 103 is interrupted (i.e., the electrical conduction is not established), so that there is a liability that the fixing offset (a phenomenon that the toner is offset to the film) generates.

In this embodiment, in this case, in S4 of the flowchart in FIG. 4, |I|≦Io is satisfied at I=0 μA, and therefore “No” is satisfied in S4, so that it is possible to detect the breakage of the fixing film 103.

FIG. 6 shows the case (breakage) where a force for shifting the fixing film 103 toward a side opposite from the electroconductive portion S side of the fixing film 103 and then the fixing film 103 is shortened by abrasion by rubbing of the fixing film 103 with a flange 121 at an end portion of the fixing film 103. As shown in FIG. 6, the fixing film 103 is abraded in the flange 121 side, and the exposed portion (electroconductive portion S) of the intermediate layer 103b moves toward the flange 121 side, so that the electroconductive brushes 111 and 112 are in non-contact with the electroconductive portion S. As a result, the bias application connection to the fixing film 103 is interrupted, so that there is a liability that the fixing offset (a phenomenon that the toner is offset to the film) generates.

In this embodiment, also in this case, in S4 of the flowchart in FIG. 4, |I|≦Io is satisfied at I=0 μA, and therefore “No” is satisfied in S4, so that it is possible to detect the breakage of the fixing film 103.

In this embodiment, the electroconductive portion S of the fixing film 103 is 7 mm±0.5 mm in width, and each of the electroconductive brushes 111 and 112 is 5 mm±0.5 mm in width. A tolerance (play) between a position of each of the flanges 120 and 121 and a position of the fixing film 103 is ±1 mm. Even when the tolerance is accumulated, a contact state is ensured between the electroconductive portion S and each of the electroconductive brushes 111 and 112, and therefore in the case of a normal operation, |I|?Io always holds. That is, setting is made so that |I|≦Io holds only when abnormality such as the fixing film breakage generates.

### (Failure of Bias Voltage Source)

The breakage of the fixing film 103 was described above, but also with respect to the failure of the bias voltage source 110, it is possible to detect the bias voltage source failure by, e.g., comparing the absolute value |I| of the detected current value I with each of a predetermined lower limited value ILo and a predetermined upper limit value IHi. In the case of IHi>|I|>ILo, it is discriminated that the bias voltage source 110 outputs the voltage of −500 V which is a normal value, and then normal image formation may also be started. On the other hand, in the case of IHi≦|I| or |I|≦ILo, it is discriminated that the bias voltage source 110 applies an abnormal high voltage or an abnormally low voltage, so that the controller 20 discriminates that the failure of the bias voltage source 110 generates.

Then, in the case of IHi≦|I|, the controller displays a message of “bias voltage source exchange”, and in the case of |I|≦ILo, the controller 20 displays a message of “fixing device exchange or bias voltage source exchange”. Alternatively, the controller 20 sends, to the personal computer 40, the message of “bias voltage source exchange” in the case of IHi≦|I|, and the message of “fixing device exchange or bias voltage source exchange” in the case of |I|≦ILo.

For example, in the case where the bias voltage source 110 outputs the voltage of −500 (V)±15%, the resultant current value I is −5 (μA) to −12 (μA) (i.e., the absolute value |I| of the current value I is 5 (μA) to 12 (μA). The absolute value |I| of the current value I is detected at a somewhat low level due to the contamination or the like of the electroconductive brushes 111 and 112 in continuous use. Accordingly, e.g., by setting ILo=3 (μA) and IHi=13 (μA), it is also possible to detect the failure resulting from abnormal output of the bias voltage source 110. Therefore, in S4 of FIG. 4, by replacing “|I|>Io?” with “IHi>|I|>ILo?”, it is possible to detect also the failure due to the abnormal output of the bias voltage source 110.

In the above, in this embodiment, a constitution in which the breakage of the fixing film or the failure of the fixing film bias voltage source is detected by detecting the current of the fixing film bias was described. Various numerical values such as the value of the bias applied to the fixing film, the value of the protective resistor Rf and the predetermined current value Io are merely examples, and therefore may arbitrarily be set depending on the fixing device constitution. Further, in this embodiment, the monochromatic (single-color) image forming apparatus was described, but the image forming apparatus may also be a color image forming apparatus including, e.g., four image forming portions for four colors.

(Effect of this Embodiment)

In this embodiment, in the fixing device of the film heating type in which the bias is applied to the fixing film, during the fixing step (fixing process) in which the fixing device heats and presses the recording material, the surface potential of the fixing film is maintained at the predetermined potential so that the degree of the fixing offset is lowered. Then, in a period (during non-fixing process) other than the period of the fixing step, the abrasion or breakage of the fixing film or the failure of the bias voltage source is accurately detected, so that it becomes possible to early notify a user or operator of the exchange of the fixing device. As a result, it is possible to provide the fixing device and the image forming apparatus, in which image defect and improper feeding of the recording material do not generate.

That is, the breakage of the fixing film 103 and the failure of the bias voltage source 110 can be detected by detecting the current of the fixing film bias in this embodiment, so that it is possible to prevent the fixing offset of the recording material, the image defect resulting from the fixing trailing and the improper feeding of the recording material, due to the above-described breakage and failure.

### Second Embodiment

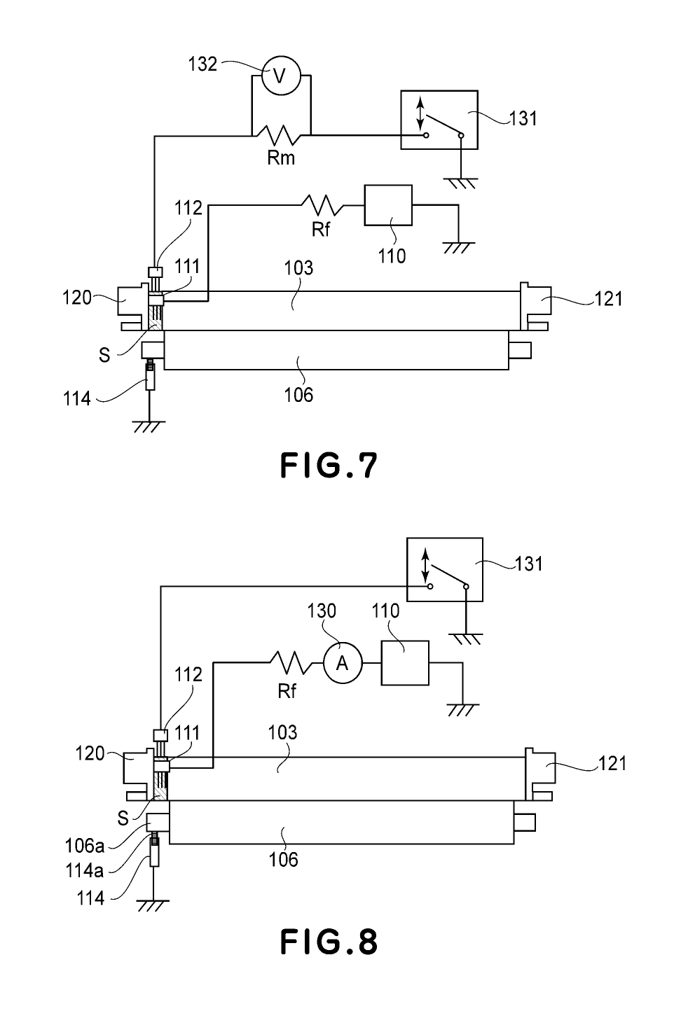

In First Embodiment, the constitution in which the current value of the current passing through the endless belt was detected by the ammeter disposed in the current detecting path other than the electric voltage supplying path for the fixing film bias was employed. On the other hand, this embodiment is different from First Embodiment in that a voltage value of a voltage applied to the endless belt is detected, in order to discriminate whether or not the electrical conduction is established, by a voltmeter (functioning as the detecting portion) disposed in a voltage detecting path other than the electric voltage supplying path for the fixing film bias. FIG. 7 is a schematic illustration of a fixing device of the film heating type in this embodiment. In FIG. 7, in place of the ammeter 130, a detecting resistor Rm and a voltmeter 132 for measuring the voltage at both terminals thereof are provided.

In this embodiment, e.g., the voltage of −500 (V) is outputted from the bias voltage source 110, and in the case of, e.g., Rm=50 (MΩ) (equal to Rf), the value of the current I passing through the resistor Rm in the normal state is −3 (μA) to −5 (μA). As a result, the detected voltage value V is −150 (V) to −250 (V), i.e., the absolute value |V| of the voltage value V is 150 (V) to 250 (V). The absolute value |V| of the voltage value V is detected at a somewhat low level due to the contamination or the like of the electroconductive brushes 111 and 112 in continuous use. Accordingly, by comparing the absolute value |V| of the detected voltage V with a predetermined value Vo=75 (V), it is possible to detect the breakage of the fixing film breakage and the failure of the fixing film bias voltage source.

Further, in FIG. 4, by replacing the current detection with the voltage detection and by replacing the current value discrimination “|I|>Io?” with the voltage value discrimination “|V|>Vo?”, also to this embodiment, the flowchart of FIG. 4 is applicable.

In this embodiment, the fixing device in which the current detection of the fixing film bias is replaced with the voltage detecting of the fixing film bias is used, and when the detected voltage value is compared with the detected current value, a large value can be detected, so that the fixing device has an advantage that a measurement error is small. In this embodiment, the detected resistor value Rm is 50 (MΩ) which is equal to the value of the protective resistor Rf (=50 (MΩ), but may also be set at an arbitrary value.

### Third Embodiment

In First Embodiment, the constitution in which the current value was detected by the ammeter disposed in the current detecting path other than the electric voltage supplying path for the fixing film bias was employed. On the other hand, this embodiment is different from First Embodiment in that a voltage detecting path other than the electric voltage supplying path for the fixing film bias is disposed, and a voltage value of a voltage applied to the endless belt is detected by the ammeter disposed in the electric voltage supplying path. As shown in FIG. 8, in this embodiment, compared with First Embodiment, the ammeter 130 shown in FIG. 2 in First Embodiment is merely moved to the electric voltage supplying path for the fixing film bias, and the measured current values are the same as those in First Embodiment. Accordingly, it is possible to detect the breakage of the fixing film and the failure of the fixing film bias voltage source by applying the flowchart of FIG. 4 as it is.

Also in this embodiment, during the fixing step (fixing process) in which the toner image is fixed on the recording material, the switching means (switch portion) 131 is turned off (opened). However, in this embodiment, during the fixing step (fixing process) in which the toner image is fixed on the recording material, the ammeter 130 is disposed in the electric voltage supplying path for the fixing film bias and a closed circuit is formed via the electroconductive brush 111 and the terminal member (ground portion) 114, and therefore it is possible to detect pin hole leakage of the pressing roller described below.

In FIG. 8, the electroconductive brush 111 is provided at the first position of the electroconductive portion S which is the first electroconductive portion provided at the longitudinal end portion side of the fixing film (first rotatable member) 103 which is the endless belt. On the other hand, the terminal member 114 is provided at a third position 114a on the core metal 106a which is the second electroconductive portion provided at the longitudinal end portion side of the pressing roller (second rotatable member) 106 which is another rotatable member.

The pin hole leakage is a phenomenon such that a hole (pin hole) generates in the PFA tube of the pressing roller 106 and the current of the fixing film bias flows into the inside of the PFA tube through the pin hole. By the pin hole leakage, through the pin hole generating in the PFA tube of the pressing roller 106, the current of the fixing film bias flows along the path in the order of the bias voltage source 110, the intermediate layer 103b, the top layer 103c, the electroconductive elastic layer 106b, the core metal 106a, the terminal member 114 and the ground.

The pin hole in the pressing roller 106 generates due to passing of the foreign matter through the nip N, abrasion of the top layer 106c by the recording material end portion in continuous use, or the like. It is turned out that when a minute pin hole generates in the pressing roller 106, the pin hole largely grows by the repetitive application of the fixing film bias. When the pin hole becomes large, the current value also becomes large due to the pin hole leakage, so that also a lowering in surface potential of the fixing film 103 becomes large.

Further, when the pin hole of the pressing roller 106 becomes large, the electroconductive elastic 106b (FIG. 1) low in parting property is exposed, and the toner T is deposited thereon, so that toner contamination generates on the back side of a print surface of the recording material. When the current due to the pin hole leakage becomes large, dielectric breakdown of the top layer 103c of the fixing film 103 generates and the pin hole generates in the top layer 103c, so that the intermediate layer 103b low in parting property is exposed and the toner T is deposited thereon. As a result, the toner contamination generates on the print surface of the recording material. In such a case, not only exchange of the pressing 106 but also exchange of the fixing film 103 are needed. Accordingly, it is preferable that the pin hole of the pressing roller 106 is formed out of an initial stage in which the pin hole is small.

In the case where the pin hole of the pressing roller 106 generates in a non-sheet-passing region (region where the pressing roller 106 does not contact the recording material with respect to the longitudinal direction thereof) of the pressing roller 106, during the fixing step, the fixing film bias current flows into the pin hole, so that the absolute value of the surface potential of the fixing film 103 lowers. Therefore, in a region where the surface potential of the fixing film 103 is lowered by the pin hole leakage, there is a liability that the fixing offset generates.

For example, in the case where the voltage of −500 (V) is applied from the bias voltage source 110, when there is no generation of the pin hole leakage, the surface potential of the fixing film 103 is about −500 (V). On the other hand, in the case where the pin hole leakage generated, the surface potential of the fixing film 103 having a width of about 12 mm in the nip region where the pin hole leakage generated is lowered to about −100 (V).

In a state in which the switching means 131 is turned off (opened) and the bias application of the bias voltage source 110 and rotation of the fixing film are turned on, when there is no generation of the pin hole in the pressing roller 106 in a state in which the recording material does not exist at the nip N, the current value I detected by the ammeter 130 is about 0 (μA). On the other hand, in the case where the pin hole exists in the pressing roller 106, the fixing film bias current flows into the pressing roller 106, and therefore although the current value I varies depending on the size of the pin hole, the current value is about −3 (μA) (i.e., the absolute value |I| of the current value I is 3 (μA).

The state in which the recording material does not exist at the nip N refers to those during pre-fixing rotation before the recording material reaches the nip N, during a recording material interval, and during post-fixing rotation from after passing of the final recording material through the nip N until the final recording material is discharged to the outside of the image forming apparatus.

Then, in the state in which the switching means 131 is turned off (opened) and the bias application of the bias voltage source 110 and the fixing film rotation are turned on, during each of the pre-fixing rotation, the recording material interval and the post-fixing rotation, an absolute value of the current value I is |I|, and a predetermined value of the current value I is Ip. In the case where |I|≧Ip is detected (Ip=3 (μA) in this embodiment), the controller 20 displays a message of “pressing roller exchange” at the display portion 30 of the image forming apparatus main assembly. Alternatively, the controller 20 sends a signal for “pressing roller exchange” to the personal computer 40.

In this embodiment, the reason why the detection of the pin hole leakage is not performed during the fixing step is that in a high-humidity environment, the fixing film bias current flows into the electroconductive discharging roller via the recording material. However, in the case where the current flowing into the discharging roller is very small when compared with the predetermined value Ip, also during the fixing step, the pin hole leakage detection may also be performed.

(Effect of this Embodiment)

In this embodiment, by disposing the ammeter for detecting the fixing film bias current in the electric voltage supplying path, it is possible to detect not only the breakage of the fixing film 103 and the failure of the bias voltage source 110 but also the pin hole leakage of the pressing roller 106. As a result, it is possible to reduce not only a degree of the fixing effect due to the pin hole leakage but also the image defect such as the toner contamination.

### Fourth Embodiment

In First to Third Embodiments, the case where the elastic layer 106b (FIG. 1) of the pressing roller 106 is formed of the electroconductive material was described, but in this embodiment, the case where the elastic layer 106b of the pressing roller 106 is formed of an insulating material (i.e., the case where the current does not flow even when the pin hole generates) will be described.

In this embodiment, by using an insulating silicone rubber as the material for the elastic layer 106b of the pressing roller 106, the surface potential of the pressing roller 106 is increased to about −300 V in absolute value in the negative side, so that the degree of the fixing offset is somewhat increased. However, even when the pin hole generates in the PFA tube of the surface layer 106c (FIG. 1) of the pressing roller 106, by the insulating silicone rubber of the elastic layer 106b, the current does not flow, and therefore the pressing roller 106 has an advantage that the pin hole leakage described in Third Embodiment does not generate.

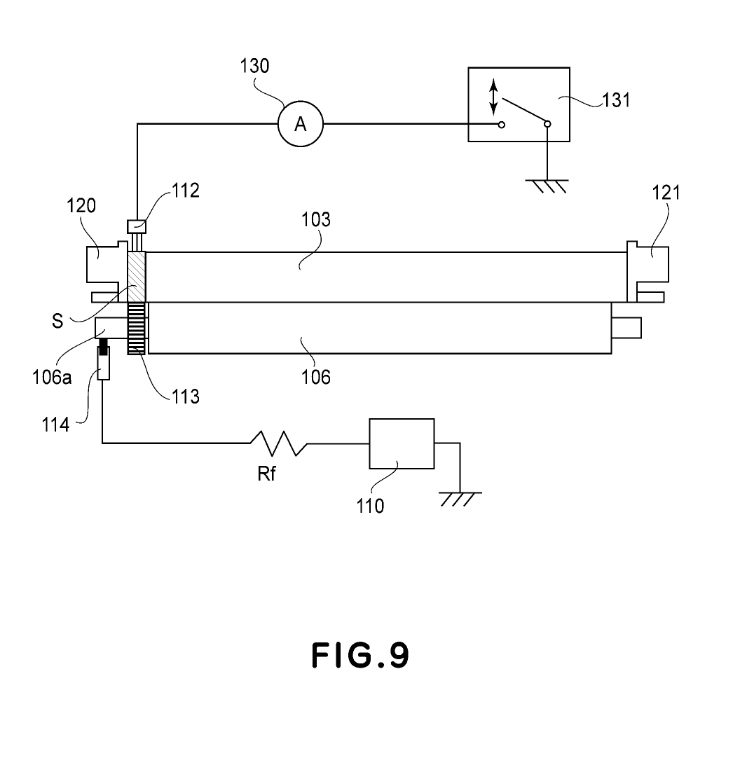

FIG. 9 is a schematic illustration of a fixing device of the film heating type in this embodiment. As shown in FIG. 9, a constitution in which the bias voltage source 110 for applying the bias to the fixing film 103 is connected with the terminal member 114 and in which the fixing film bias is applied to the electroconductive portion S via the core metal 106a and an electroconductive rubber ring (electroconductive portion) 113 is employed.

In this embodiment, a constitution in which the electroconductive brush 111 is omitted to reduce a cost is employed. By using the electroconductive rubber ring 113 and the terminal member 114 in place of the electroconductive brush 111, it is possible to detect the abrasion or breakage of the fixing film or the failure of the fixing film bias voltage source. The fixing film bias current detection by the ammeter 130 is made by applying the flowchart of FIG. 4 as it is, so that it is possible to detect the fixing film breakage and the failure of the fixing film bias voltage source.

### Fifth Embodiment

In First to Fourth Embodiments, the structure of the fixing film 103 as the fixing member was described as the structure including the polyimide base layer 103a, the intermediate layer 103b as the electroconductive primer and the top layer 103c as the parting layer. On the other hand, in this embodiment (two specific embodiments), the structure of the fixing belt as the fixing member is different from those in First to Fourth Embodiments.

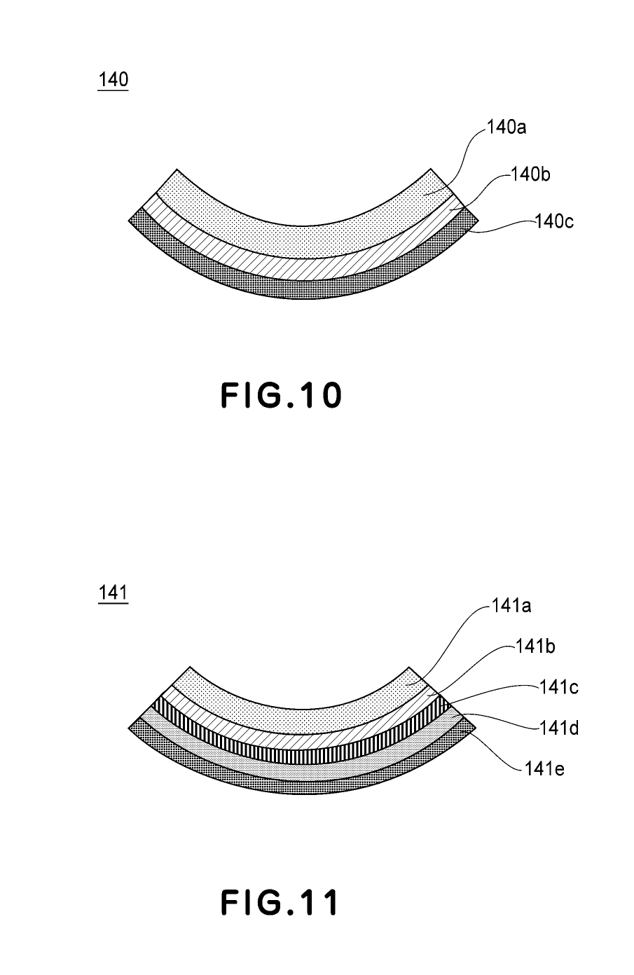

First, as a first specific embodiment, FIG. 10 is a schematic sectional view of a fixing belt 140 in which the base layer is formed of metal. In FIG. 10, a base layer 140a is formed of a metal material such as SUS, and is 30 mm in inner diameter, 235 mm in length and 40 mm in thickness. For example, on the base layer 140a which is a cylindrical member, a 4 μm-thick intermediate layer 140b as a primer is coated, and thereon a 15 μm-thick top layer 140c, as the parting layer, formed of PFA, PTFE or the like is coated.

In the first specific embodiment, the reason why the fixing member in FIG. 10 is referred to as the fixing belt is that the base layer is constituted by metal and therefore has a large rigidity when compared with the fixing film 103 in which the base layer is formed of polyimide. In the case where the electroconductive base layer 140a of SUS is exposed as the electroconductive portion S (7 mm in width) at the end portion of the fixing belt 140, the intermediate layer 140b may have either of the electroconductive property or the insulating property, and can be selected in view of priority in adhesiveness to the top layer 140c and the base layer 140a. Further, the fixing film bias application to the fixing belt 140 is made by applying the fixing film bias to the electroconductive portion S which is an exposed portion of the base layer 140a of the electroconductive SUS material.

In this specific embodiment, only by replacing the fixing film 103 in First to Fourth Embodiments with the fixing belt 140, it is possible to apply First to Fourth Embodiments and the flowchart of FIG. 4.

In this specific embodiment, the base layer 140a of the fixing belt 140 is formed of the metal material having a high thermal conductivity compared with the resin material such as polyimide, and therefore the first specific embodiment has advantages that heat conduction from the heater 101 is good and that speed-up of the fixing device and the image forming apparatus can be realized.

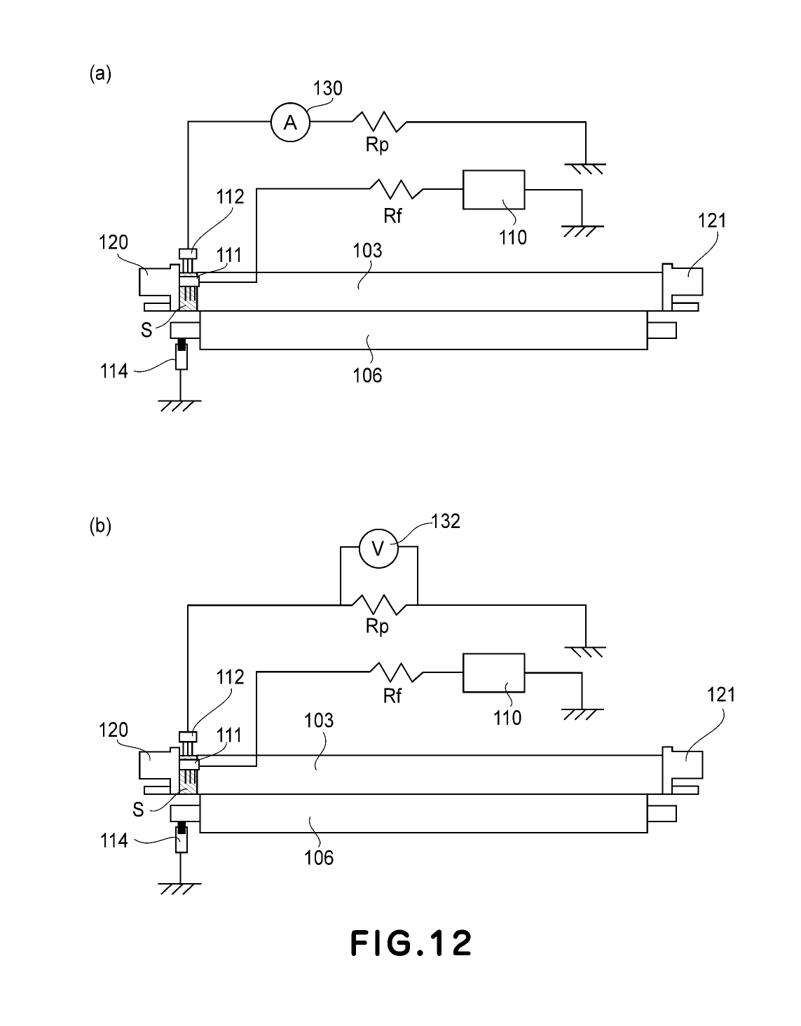

Next, as a second specific embodiment, another fixing belt (including the elastic layer) will be described. FIG. 11 is a schematic sectional view of a fixing belt 141 in the second specific embodiment. In FIG. 11, a base layer 141a is formed of the heat-resistant resin material such as polyimide or the metal material such as SUS. The base layer 141a may preferably be formed of polyimide in the case where the image forming apparatus is a low-speed machine and may preferably be formed of SUS in the case where the image forming apparatus is a high-speed machine.

In the second specific embodiments, on a cylindrical member as the heat-resistant polyimide base layer 141a of 24 mm in inner diameter, 235 mm in length and 60μ in thickness, a 4 μm-thick intermediate layer 141b as the primer layer is coated. On the intermediate layer 141b, a 300 μm-thick elastic 141c of an insulating silicone rubber is coated. Further, on the elastic layer 141c, a 4 μm-thick intermediate layer 141d as the primer layer is coated, and thereon, a 30 μm-thick top layer 141e, of a PFA tube, as the heat-resistant parting layer is coated.

In the second specific embodiment, the reason why the fixing member is referred to as the fixing belt is that compared with the fixing film 103 in which the base layer is formed of polyimide, the elastic layer 141c is coated and therefore the rigidity is large.

In the case where the intermediate layer 141b is exposed as the electroconductive portion S (7 mm in width) at the end portion of the fixing belt 141, an electroconductive primer is used as the intermediate layer 141b. On the other hand, in the case where the intermediate layer 141d is exposed, the electroconductive primer is used as the intermediate layer 141d. Whether which one of the intermediate layers 141b and 141d is exposed as the electroconductive portion S may arbitrarily set depending on the fixing device. In the case where the electroconductive SUS material is used as the material for the base layer 141a when the image forming apparatus is the high-speed machine, the base layer 141a may also be exposed as the electroconductive portion S.

In this specific embodiment, a constitution in which the electroconductive primary is used as the intermediate layer 141b and the end portion of the intermediate layer 141b is exposed as the electroconductive portion S and in which the fixing film bias is applied to the electroconductive portion S was employed. This is because in the case where a constitution in which the electroconductive primer is used as the intermediate layer 141d and the end portion of the intermediate layer 141b is exposed as the electroconductive portion S and in which the fixing film is applied to the electroconductive portion S was employed, a crack generated in the intermediate layer 141d and thus a problem such that the electrical conduction was partly interrupted (blocked) at the electroconductive portion S occurred.

As a mechanism for this, when the fixing belt 141 is heated at the electroconductive portion S, a degree of thermal expansion of the electroconductive layer 141c is large and is not regulated (limited) by the PFA tube of the top layer 141e, and therefore at the electroconductive portion S, the intermediate layer 141d cannot follow the thermal expansion of the elastic layer 141c, so that the crack generates in the intermediate layer 141d. Further, the electrical conduction is partly interrupted in the region of the electroconductive portion S. For this reason, it was considered that the intermediate layer 141b may preferably be exposed.

In this specific embodiment, the fixing belt 141 includes the elastic layer 141c, and therefore the surface of the fixing belt 141 can follow the surface of the recording material such as embossed paper having large unevenness, so that the fixing belt 141 has an advantage that a fixing property at a recessed portion is remarkably improved compared with the fixing film 103 and the fixing belt 140 which do not include the elastic layer. Similarly, the surface of the fixing belt 141 can follow the surface of the toner T on the recording material P, and therefore is not readily influenced by the unevenness of the recording material as an underlying material, so that the fixing belt 141 has an advantage that glossiness of the toner image can be made uniform. The fixing belt 141 including the elastic layer 141c is principally used in a high-speed monochromatic machine or a color image forming apparatus.

In the first and second specific embodiments, as the fixing member, the fixing film 103 in First to Fourth Embodiments is only replaced with the fixing belt 141, and therefore First to Fourth Embodiments and the flowchart of FIG. 4 can be applied as they are.

### Sixth Embodiment

In First to Fifth Embodiments, the switching means (switch portion) 131 is turned on (closed) during the measurement of the fixing film bias and is turned off (opened) during the fixing step of the toner image on the recording material. This embodiment is different from First to Fourth Embodiments in that a constitution in which the switching means 131 is omitted (removed) and in which the fixing film bias is always measurable during the fixing film bias application is employed. In FIG. 12, (a) and (b) are schematic sectional views of fixing devices of the film heating type in this embodiment (two specific embodiments). In this embodiment, the switching means 131 is removed and a detection resistor Rp is added as shown in (a) of FIG. 12 showing a first specific embodiment and (b) of FIG. 12 showing a second specific embodiment.

By providing the detection resistor Rp with a proper resistance value, the surface potential of the fixing film 103 is maintained, so that it becomes possible to not only reduce degrees of the fixing offset and the fixing trailing but also measure the fixing film bias current. In this embodiment, the detection resistor Rp has the resistance value of 450 (MΩ). The protective resistor Rf has the resistance value of 50 (MΩ) and the bias voltage source 110 applies the voltage of −500 (V), and therefore the current passing through the protective resistor Rf and the detection resistor Rp, i.e., the absolute value |I| of the current value detected by the ammeter 130 is about 1 (μA).

At this time, the bias applied to the electroconductive portion S of the fixing film 103 is −450 (V), so that the surface potential of the fixing film 103 is about −450 (V). When compared with First Embodiment, the surface potential of the fixing film 103 becomes small by about 50 (V), and therefore the degree of the fixing offset and the fixing trailing somewhat increase. However, increased degrees are at levels of no problem, so that the degree of the fixing offset and the fixing trailing can be sufficiently decreased.

In the first specific embodiment shown in (a) of FIG. 12, the current value I detected by the ammeter 130 is always −0.6 (μA) to −1.0 (μA), and by comparing the current value I with Io=0.3 (μA), it is possible to detect the breakage of the fixing film and the failure of the fixing film bias voltage source. That is, in the first specific embodiment, when |I|<0.3 (μA) is detected, the controller discriminates that the breakage of the fixing film 103 or the failure of the fixing film bias voltage source generates. Accordingly, when compared with First Embodiment, the current value becomes about 1/10, so that the ammeter 130 is required to have high detection accuracy, and therefore there is a need to use a relatively expensive ammeter.

That is, in the first specific embodiment, the switching means 131 can be removed and thus the fixing film has the advantage that the fixing film bias current is always measurable during the fixing film bias current application.

On the other hand, the second specific embodiment shown in (b) of FIG. 12 has a constitution having a combination of First Embodiment and Second Embodiment. That is, the ammeter 130 is omitted (removed) and a voltmeter 132 is disposed so as to measure a voltage of the detection resistor Rp at both terminals of the resistor Rp. In the second specific embodiment, in the normal state, the voltage value V detected by the voltmeter 132 is −270 (V) to −450 (V), and thus the absolute value |V| of the voltage value V is 270 (V) to 450 (V). Accordingly, by comparing the absolute value |V| of the detected value V with a predetermined value Vo=135 (V), and |V|≦135 (V) is detected, so that it is possible to detect the breakage of the fixing film and the failure of the fixing film bias voltage source.

In the second specific embodiment, the switching means 131 can be removed, and the fixing film 103 has advantages that the fixing film bias current is always measurable in the form of the voltage during the fixing film bias application and that a general-purpose voltmeter can be used as the voltmeter 132 and thus a cost can be reduced.

In this embodiment (first and second specific embodiments), when the bias value of the bias voltage source 110 is set at −550 (V), the bias applied to the electroconductive portion S is about −500 (V), so that the surface potential of the fixing film 103 can made about −500 (V). In this case, it is possible to obtain an effect, of reducing the degrees of the fixing offset and the fixing trailing, similar to the effect of First Embodiment. Therefore, in this embodiment, the output value of the bias voltage source 110 may preferably be increased.

The above-described Embodiments are preferred embodiments of the present invention, but the present invention is not limited to these Embodiments, and can be modified variously within the scope of the present invention.

For example, in the above-described Embodiments, the example in which the endless belt contacts the unfixed toner image-carrying surface of the recording material is employed, but an example in which the endless belt contacts an opposite surface, of the recording material, from the unfixed toner image-carrying surface may also be employed.

In the Embodiments described above, when the electrical conduction is not established, the abnormality or the warning is displayed, but the apparatus may also be stopped, i.e., the operation of the apparatus may also be forbidden. Further, together with the display of the abnormality or the warning, the apparatus may be stopped.

In the Embodiments described above, as the image heating apparatus, the fixing device for fixing the unfixed toner image on the recording material was described as an example, but the present invention is not limited thereto. In order to improve glossiness of the image, the present invention is also applicable to a device (apparatus) for heat-pressing the toner image fixed on the recording material.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 249058/2013 filed Dec. 2, 2013, which is hereby incorporated by reference.

What is claimed is:

1. An image heating apparatus comprising:
an endless belt configured to heat a toner image on a recording material at a nip;
an electroconductive portion provided along a circumferential direction of said endless belt at a longitudinal end portion of said endless belt;
a first contact portion and a second contact portion which contact said electroconductive portion at different positions with respect to the circumferential direction;
an electric voltage supplying portion configured to supply an electric voltage to said electroconductive portion through said first contact portion; and
a detecting portion configured to detect, whether or not electrical conduction is established, through said second contact portion.

2. An image heating apparatus according to claim 1, wherein said electroconductive portion is provided over a full circumference of said endless belt at the longitudinal end portion.

3. An image heating apparatus according to claim 2, further comprising a rotating mechanism configured to rotate said endless belt,
wherein said electric voltage supplying portion provides electric voltage supply over a period in which said endless belt rotates at least one-full turn, and
wherein said detecting portion detects, whether or not the electrical conduction is established, over the period.

4. An image heating apparatus according to claim 3, further comprising a controller configured to control an operation of said rotating mechanism,
wherein said controller stops said rotating mechanism when said detecting portion does not detect that the electrical conduction is established.

5. An image heating apparatus according to claim 4, wherein said rotating mechanism includes a rotatable driving member configured to form a nip in cooperation with said endless belt and configured to drive said endless belt, and
wherein said controller stops said rotating mechanism when said detecting portion does not detect that the electrical conduction is established.

6. An image heating apparatus according to claim 3, wherein said electric voltage supplying portion provides electric voltage supply by voltage application, and
wherein said detecting portion detects whether or not a current flows with the voltage application by said electric voltage supplying portion.

7. An image heating apparatus according to claim 6, further comprising a switch portion provided in an electrical path from said second contact portion to a ground,
wherein said switch portion is turned off in a period in which the recording material passes through the nip and is turned on when said detecting portion detects whether or not the electrical conduction is established with the voltage application by said electric voltage supplying portion in a period in which the recording material does not exist at the nip.

8. An image heating apparatus according to claim 7, wherein in the period in which the recording material passes through the nip, said electric voltage supplying portion applies a voltage of an identical polarity to a normal charge polarity of a toner.

9. An image heating apparatus according to claim 1, wherein said rotating mechanism includes a roller configured to form a nip in cooperation with said endless belt and configured to drive said endless belt and includes a ground portion configured to established a ground for a core metal of said roller.

10. An image heating apparatus according to claim 1, wherein said endless belt includes a base layer and a parting layer provided on the base layer, and
wherein the base layer performs a function as said electroconductive portion.

11. An image heating apparatus according to claim 1, wherein said endless belt includes a base layer and a parting layer provided on the base layer, and
wherein an adhesive layer for adhesively bonding the base layer and the parting layer performs a function as said electroconductive portion.

12. An image forming apparatus comprising:
an image forming portion configured to form a toner image on a recording material;
an endless belt configured to heat, at a nip, the toner image formed on the recording material by said image forming portion;
an electroconductive portion provided along a circumferential direction of said endless belt at a longitudinal end portion of said endless belt;
a first contact portion and a second contact portion which contact said electroconductive portion at different positions with respect to the circumferential direction;
an electric voltage supplying portion configured to supply an electric voltage to said electroconductive portion through said first contact portion;
a detecting portion configured to detect, whether or not electrical conduction is established, through said second contact portion; and
a sending portion configured to send a signal for notifying an error when the detecting portion does not detect that the electrical conduction is not established although said electric voltage supplying portion provides electric voltage supply.

13. An image forming apparatus according to claim 12, wherein said electroconductive portion is provided over a full circumference of said endless belt at the longitudinal end portion.

14. An image forming apparatus according to claim 13, further comprising a rotating mechanism configured to rotate said endless belt,
wherein said electric voltage supplying portion provides electric voltage supply over a period in which said endless belt rotates at least one-full turn, and
wherein said detecting portion detects, whether or not the electrical conduction is established, over the period.

15. An image forming apparatus according to claim 14, further comprising a controller configured to control an operation of said rotating mechanism,
wherein said controller stops said rotating mechanism when said detecting portion does not detect that the electrical conduction is established.

16. An image forming apparatus according to claim 15, wherein said rotating mechanism includes a rotatable driving member configured to form a nip in cooperation with said endless belt and configured to drive said endless belt, and
wherein said controller stops said rotating mechanism when said detecting portion does not detect that the electrical conduction is established.

17. An image forming apparatus according to claim 14, wherein said electric voltage supplying portion provides electric voltage supply by voltage application, and
wherein said detecting portion detects whether or not a current flows with the voltage application by said electric voltage supplying portion.

18. An image forming apparatus according to claim 17, further comprising a switch portion provided in an electrical path from said second contact portion to a ground,
wherein said switch portion is turned off in a period in which the recording material passes through the nip and is turned on when said detecting portion detects whether or not the electrical conduction is established with the voltage application by said electric voltage supplying portion in a period in which the recording material does not exist at the nip.

19. An image forming apparatus according to claim 18, wherein in the period in which the recording material passes through the nip, said electric voltage supplying portion applies a voltage of an identical polarity to a normal charge polarity of a toner.

20. An image heating apparatus comprising:
an endless belt configured to heat a toner image on a recording material at a nip;
a roller configured to form a nip in cooperation with said endless belt and configured to drive said endless belt,
a first electroconductive portion provided along a circumferential direction of said endless belt at a longitudinal end portion of said endless belt;
a first contact portion contacting said first electroconductive portion;
a second portion, provided on a core metal of said roller, contacting said first electroconductive portion;
a second contact contacting the core metal of said roller;
an electric voltage supplying portion configured to supply an electric voltage to said second electroconductive portion through said second contact portion; and
a detecting portion configured to detect, whether or not electrical conduction is established, through said first contact portion.
